(19) United States
(12) Patent Application Publication
(10) Pub. No.: US 2012/0219801 A1
(43) Pub. Date: Aug. 30, 2012

(54) HYDROPHOBIC AND LIPOPHOBIC COATING MATERIAL

(76) Inventor: Yu-Hui HUANG, Taoyuan County (TW)

(21) Appl. No.: 13/035,596

(22) Filed: Feb. 25, 2011

(51) Int. Cl. B32B 27/36; B32B 17/06; B32B 27/30; C07F 7/21; B32B 13/04; B82Y 30/00

(52) U.S. Cl. 428/412; 556/452; 428/446; 428/428; 428/451; 977/773

(57) ABSTRACT

A hydrophobic and lipophobic coating material comprising nanoparticles with a molecule having the formula (I):

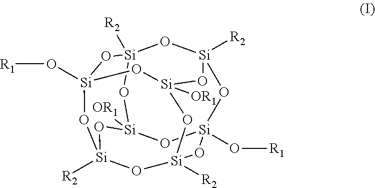

wherein R1 is selected from a group consisting of halogens, hydrogen, alkyl groups, alkoxy groups, hydroxyl group, alkenyl groups, alkynyl groups, acyl groups, aryl groups, carboxyl groups, alkoxycarbonyl groups, and aryloxycarboxyl groups, and wherein R2 is a functional group containing fluorine. The coating material may be coated on an outer cover or a conductive layer of a touchscreen. The coating material has superior hydrophobicity and lipophobicity, facilitating a touchscreen easy to clean and exempting the touchscreen from fingerprints and oily stains. The coating material also has superior antiglare effect.

### FIELD OF THE INVENTION

The present invention relates to a coating material and a touchscreen coated with the same, particularly to a hydrophobic and lipophobic coating material and a touchscreen coated with the same.

### BACKGROUND OF THE INVENTION

In comparison with the conventional input devices, a touchscreen allows a user to input instructions with his finger intuitively. Besides, a touchscreen features superior human-machine interaction and has advantages of fast operation, high precision and small volume. Therefore, touchscreens have gradually replaced conventional input devices, such as keyboards and mice, and has been extensively used in various consumer electronics, such as person computers, mobile communication devices, portable media players, and electronic books. At present, most of the touchscreens available in the market belong to the resistive type and the capacitive type.

The basic structure of a resistive touchscreen includes two ITO (Indium Tin Oxide) films and a plurality of point-type spacers. The point-type spacers are arranged between the ITO films to separate them by a specified distance. When a user contacts the ITO film, a conduction state occurs in the ITO films and causes a resistance variation. Via the resistance variation, a sensor determines the coordinates of the contact point. However, the resistive touchscreen using ITO films has disadvantages of poor light transmittance and low wear resistance. Besides, ITO films may distort after long-term and repeated compression.

The capacitive touchscreens are developed to overcome the abovementioned problems. According to their structures, the capacitive touchscreens may be categorized into the surface type and the projective type. The surface type capacitive touchscreen includes a glass substrate, a conductive film formed on the glass substrate, a patterned electrode on the conductive film, and a wear-resistant layer covering the abovementioned components. The surface type capacitive touchscreen provides voltage from the four corners to generate a uniform electric field. When a user contacts the touchscreen with his finger, the electric field would be changed. A controller determines the contact point via detecting the ratio of induced currents from the different corners. The projective type capacitive touchscreen includes a glass substrate and an arrayed ITO electrode layer on the glass substrate. When a user contacts the touchscreen with his finger, the capacitance of the electrode layer would be changed. The contact point is determined via the capacitance variation.

No matter what type the touchscreen is, users have to touch the surface of the touchscreen to input instructions or operate the computer. The dust or oil of the finger may adhere to the surface of the touchscreen and leave traces or fingerprints, which degrades the appearance esthetics, lowers the sensitivity and hinders users from recognizing the information. Besides, under intense light, the glassy surface of a touchscreen generates glare that makes the user unable to view the contents presented on the touchscreen.

### SUMMARY OF THE INVENTION

The primary objective of the present invention is to overcome the problem that dirt is likely to adhere to a touchscreen, degrade appearance esthetics, lower the sensitivity, and hinder users from recognizing the information presented on the touchscreen. In addition, the present invention also overcomes the problem that a touchscreen is likely to generate glare under intense light.

To achieve the abovementioned objective, the present invention proposes a hydrophobic and lipophobic coating material, which comprises nanoparticles with a molecule having the formula (I):

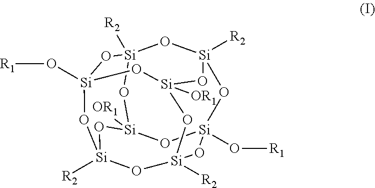

wherein R1 is selected from a group consisting of halogens, hydrogen, alkyl groups, alkoxy groups, hydroxyl group, alkenyl groups, alkynyl groups, acyl groups, aryl groups, carboxyl groups, alkoxycarbonyl groups, and aryloxycarboxyl groups; and wherein R2 is a functional group containing fluorine.

The present invention also discloses a touchscreen coated with the abovementioned hydrophobic and lipophobic coating material. The touchscreen has a conductive layer to be coated with the coating material.

The present invention also discloses a touchscreen coated with the abovementioned hydrophobic and lipophobic coating material. The touchscreen has an outer cover to be coated with the coating material.

The hydrophobic and lipophobic coating material of the present invention has the following advantages:

1. The coating material of the present invention has superior hydrophobicity, which hinders water from adhering to the coating material and conveniences users to clean the surface coated with the coating material.

2. The coating material of the present invention also has superior lipophobicity, which hinders oil or dirt from adhering to the coating material lest fingerprints and oily dirt left be left on the coating material.

3. The coating material of the present invention would not peel off from touchscreens but can securely adhere to surfaces of touchscreens via the silicon functional groups thereof. Therefore, the hydrophobic and lipophobic coating material of the present invention neither poisons human bodies nor pollutes the environment.

4. After the hydrophobic and lipophobic coating material has been coated on a touchscreen, the spherical structure of the nanoparticles generates a superior antiglare effect.

### DETAILED DESCRIPTION OF THE PREFERRED EMBODIMENTS

The present invention proposes a hydrophobic and lipophobic coating material, which comprises nanoparticles with a molecule having the formula (I):

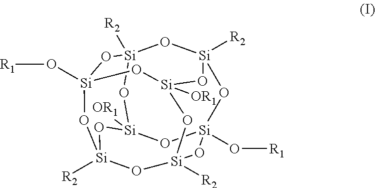

R1 is selected from a group consisting of halogens, hydrogen, alkyl groups, alkoxy groups, hydroxyl group, alkenyl groups, alkynyl groups, acyl groups, aryl groups, carboxyl groups, alkoxycarbonyl groups, and aryloxycarboxyl groups. Further, R1 is preferably selected from a group consisting of —H, —OH, —OCH₃, —OC₂H₅, —CH₃, —CH═CH₂, OCH₄OCH₃ and —C₃H₆COOC₂H₅. R2 is a functional group containing fluorine. R2 is preferably Fₙ, wherein n is an integer greater than 1. Alternatively, R2 is selected from a group consisting of fluoropolyamide groups, fluoropolyimide groups, fluorobenzoyl groups, fluoroalkyl groups, fluorosilyl groups, fluoromethyl groups, 3-chloro-4-fluoro-benzenamine groups, perfluoroalkylolethoxyl groups, and N-perfluorooctylsulfonamide groups.

The hydrophobic and lipophobic coating material of the present invention is fabricated via adding stabilizers into a sol-gel with silicon functional groups (SiOₓ) and organic molecules. The molecules in a sol-gel state are interacted mutually by non-covalent bonds, such as hydrogen bonds, Van der Waals force, and coordinate bonds, to form supermolecules. Thereby, the sol-gel has superior uniformity, dispersiveness and stability. After added into the abovementioned sol-gel, the stabilizers retard the growth of a portion of particles. Thereby is formed a plurality of transparent spherical nanoparticles. In the present invention, the stabilizers are selected from a group consisting of organic amines (such as trioctylamine, octylamine, dodecylamone, hexylamine, pyridine, oleamine, quaternary ammonium groups), thiols (such as octylthiol groups, dodecylthiol groups, and thiophenol groups), phosphino compounds (such as triphenylphosphonio groups, tributylphosphino groups, and trioctylphosphino groups), acids (such as sulfuric acid, nitric acid, hydrochloric acid, and acetic acid), bases (such as sodium hydroxide, potassium hydroxide and ammonium hydroxide), alcohol groups (such as methanol, ethanol, ethylene glycol, propanol, and isopropanol), and alkyl groups (methane, ethane, propane, butane, pentane, hexane, heptane, octane, dodecane, tridecane, tetradecane, pentadecane, hexadecane, heptadecane, and octadecane). In the present invention, the nanoparticles have a diameter of 100-200 nm.

The hydrophobic and lipophobic coating material of the present invention can be applied to various touchscreens. For example, the coating material of the present invention can be coated on a conductive layer of a touchscreen to form an antiseptic layer containing the nanoparticles, wherein the conductive layer is made of ITO (Indium Tin Oxide), ATO (Antimony Tin Oxide), AZO (Aluminum Zinc Oxide), or IZO (Indium Zinc Oxide). The coating material can also be coated on the outer cover of a touchscreen to form an antiseptic layer containing the nanoparticles, wherein the outer cover is made of glass, PMMA (poly(methyl methacrylate)), PVC (PolyVinyl Chloride), PC (PolyCarbonate), PET (poly(ethylene terephthate)), or PI (polyimide). After being coated on the conductive layer or the outer cover of a touchscreen, the coating material is heated at a temperature of 25-250° C. Thereby, covalent bonds are formed between the surface of the conductive layer (or outer cover) and the silicon functional groups of the nanoparticles. The covalent bonds make the antiseptic layer securely adhere to the surface and hard to peel off.

Below are described in detail the embodiments of the present invention to demonstrate the method for fabricating a touchscreen coated with the hydrophobic and lipophobic coating material, and examine the hydrophobic, lipophobic and antiglare effects thereof.

### Embodiment I

A Process to Fabricate a Touchscreen Coated with an Hydrophobic and Lipophobic Coating Material

Firstly, the hydrophobic and lipophobic coating material is coated directly on a PMMA outer cover. Alternatively, the coating material is diluted and coat on a PMMA outer cover. The material can be diluted with a solvent, such as alcohol groups (such as isopropanol or ethanol), ketone groups, ether groups, or benzene. In the present invention, the antiglare and antiseptic coating material can be diluted with 1000 times of solvent to have a concentration of 0.1 v/v %. In dilution, the coating material is mixed with the solvent to form a mixture solution, and the mixture solution is agitated in a mechanical way. For example, the mixture solution is agitated with blades; or the mixture solution is agitated with a rotation agitator; the mixture solution is oscillated up and down; the mixture solution is contained in a roller, and the roller is rolled back and forth. When reaching achieves a homogeneous and high-dispersiveness state, the mixture solution is coated on the outer cover via spray coating, dip coating, roll coating, print coating, or spin coating. Next, the outer cover coated with the coating material is placed in an environment at a temperature of 25-250° C. for at least one minute, whereby the coating material adheres to the outer cover. Then, the outer cover is cooled down. Thus is formed an antiglare and antiseptic coating on the outer cover. The gloss of the outer cover coated with the coating material can be controlled to be 15 to 150 GU (Gloss Unit).

### Embodiment II

Surface Tests of Outer Covers Coated with an Antiglare and Antiseptic Coating Material

Respectively perform surface energy tests, water droplet diameter tests, oil droplet diameter tests and fingerprint-related gloss tests on coated outer covers and uncoated outer covers.

### (1) Surface Energy Tests:

A dyne pen is used to to undertake surface energy tests. All the outer covers, which are coated with the hydrophobic and lipophobic coating material of the present invention, have surface energies smaller than 30 dynes/cm. A common glass substrate has surface energy of 47 dynes/cm. Therefore, the outer covers, which are coated with the hydrophobic and lipophobic coating material of the present invention, have lower surface energies.

### (2) Water Droplet Diameter Tests:

20 pieces of 5 cm×5 cm outer covers coated with the hydrophobic and lipophobic coating material of the present invention (an experimental group) and 20 pieces of 5 cm×5 cm uncoated outer covers (a control group) are prepared. 0.1 c.c. of water is dripped on the abovementioned two groups of outer covers, and the diameters of the water droplets on the outer covers could be measured. The results are as follows:

| Serial Number of | Result of Control | Result of Experimental |
|---|---|---|
| Group | Group (cm²) | Group (cm²) |
| 1 | 0.6 | 0.4 |
| 2 | 0.5 | 0.4 |
| 3 | 0.5 | 0.4 |
| 4 | 0.5 | 0.4 |
| 5 | 0.5 | 0.4 |
| 6 | 0.5 | 0.3 |
| 7 | 0.6 | 0.5 |
| 8 | 0.6 | 0.4 |
| 9 | 0.5 | 0.4 |
| 10 | 0.5 | 0.4 |
| 11 | 0.5 | 0.4 |
| 12 | 0.5 | 0.4 |
| 13 | 0.5 | 0.3 |
| 14 | 0.7 | 0.4 |
| 15 | 0.5 | 0.4 |
| 16 | 0.6 | 0.4 |
| 17 | 0.5 | 0.4 |
| 18 | 0.5 | 0.3 |
| 19 | 0.6 | 0.4 |
| 20 | 0.5 | 0.4 |

The results show that the average of the droplet diameters of the experimental group is smaller than 0.4 cm² and that the average of the droplet diameters of the control group is about 0.5 cm². In comparison with the control group, the outer covers, which are coated with the hydrophobic and lipophobic coating material of the present invention, have better hydrophobicity.

### (3) Oil Droplet Diameter Tests:

20 pieces of 5 cm×5 cm outer covers coated with the hydrophobic and lipophobic coating material of the present invention (an experimental group) and 20 pieces of 5 cm×5 cm uncoated outer covers (a control group) are prepared. 0.1 c.c. of oil is dripped on the abovementioned two groups of outer covers, and the diameters of the oil droplets on the outer covers could be measured. The results are as follows:

| Serial Number of | Result of Control | Result of Experimental |
|---|---|---|
| Group | Group (mm²) | Group (mm²) |
| 1 | 50 | 9 |
| 2 | 40 | 9 |
| 3 | 50 | 9 |
| 4 | 50 | 8 |
| 5 | 50 | 9 |
| 6 | 45 | 9 |
| 7 | 50 | 9 |
| 8 | 45 | 8 |
| 9 | 40 | 8 |
| 10 | 50 | 8 |
| 11 | 50 | 9 |
| 12 | 50 | 9 |
| 13 | 50 | 9 |
| 14 | 50 | 9 |
| 15 | 50 | 9 |
| 16 | 55 | 8 |
| 17 | 50 | 9 |
| 18 | 45 | 9 |
| 19 | 40 | 8 |
| 20 | 50 | 9 |

The results show that the average of the droplet diameters of the experimental group is smaller than 9 mm² and that the average of the droplet diameters of the control group is about 50 mm². In comparison with the control group, the outer covers, which are coated with the hydrophobic and lipophobic coating material of the present invention, have better lipophobicity.

### (4) Fingerprint Tests:

20 pieces of 5 cm×5 cm outer covers coated with the hydrophobic and lipophobic coating material of the present invention are prepared. A gloss meter is used to test the gloss (GU) of the coated outer covers before and after making fingerprints thereon. The results are as follows:

| Serial Number of | Results Before Making | Results After Making |
|---|---|---|
| Group | Fingerprints (GU) | Fingerprints (GU) |
| 1 | 110 | 110 |
| 2 | 110 | 110 |
| 3 | 111 | 111 |
| 4 | 110 | 111 |
| 5 | 110 | 111 |
| 6 | 115 | 113 |
| 7 | 110 | 110 |
| 8 | 110 | 110 |
| 9 | 120 | 120 |
| 10 | 110 | 110 |
| 11 | 110 | 111 |
| 12 | 115 | 115 |
| 13 | 110 | 110 |
| 14 | 110 | 110 |
| 15 | 110 | 110 |
| 16 | 110 | 110 |
| 17 | 115 | 116 |
| 18 | 110 | 110 |
| 19 | 110 | 110 |
| 20 | 115 | 115 |

The results show that the outer covers coated with the hydrophobic and lipophobic coating material of the present invention still have gloss of about 110 GU and after fingerprints are made thereon.

From the results of the above four tests, it is known that the outer covers coated with the hydrophobic and lipophobic coating material of the present invention have superior hydrophobicity and lipophobicity. Therefore, water droplets can be easily swabbed away with no water stain left on the outer cover. Further, the lipophobicity makes fingerprints or oily stains hard to adhere to the outer cover and realizes an anti-fingerprint function.

### Embodiment III

### Weather Resistance Tests

Weather resistance tests, including high temperature tests, low temperature tests, high humidity tests and thermal shock tests, on outer covers coated with the hydrophobic and lipophobic coating material of the present invention are performed as follows.

### (1) High Temperature Tests:

20 pieces of 5 cm×5 cm outer covers coated with the hydrophobic and lipophobic coating material of the present invention are prepared. A gloss meter is used to test the gloss of the coated outer covers initially and test it again after the outer covers are placed in an environment at a temperature of 80° C. for 200 hours. The results are as follows:

| | Results Before Placed | Results After Placed |
|---|---|---|
| Serial Number of | at High Temperature | at High Temperature |
| Group | (GU) | (GU) |
| 1 | 110 | 111 |
| 2 | 115 | 115 |
| 3 | 111 | 110 |
| 4 | 110 | 110 |
| 5 | 109 | 110 |
| 6 | 115 | 113 |
| 7 | 115 | 117 |
| 8 | 115 | 115 |
| 9 | 110 | 119 |
| 10 | 110 | 110 |
| 11 | 110 | 110 |
| 12 | 115 | 115 |
| 13 | 110 | 110 |
| 14 | 115 | 115 |
| 15 | 110 | 110 |
| 16 | 115 | 115 |
| 17 | 115 | 116 |
| 18 | 110 | 111 |
| 19 | 110 | 110 |
| 20 | 110 | 110 |

### (2) Low Temperature Tests:

20 pieces of 5 cm×5 cm outer covers coated with the hydrophobic and lipophobic coating material of the present invention are prepared. A gloss meter is used to test the gloss of the coated outer covers initially and test it again after the outer covers are placed in an environment at a temperature of −40° C. for 150 hours. The results are as follows:

| | Results Before Placed | Results After Placed |
|---|---|---|
| Serial Number of | at Low Temperature | at Low Temperature |
| Group | (GU) | (GU) |
| 1 | 115 | 115 |
| 2 | 115 | 115 |
| 3 | 115 | 116 |
| 4 | 110 | 110 |
| 5 | 109 | 110 |
| 6 | 115 | 115 |
| 7 | 110 | 115 |
| 8 | 115 | 115 |
| 9 | 110 | 110 |
| 10 | 112 | 115 |
| 11 | 110 | 110 |
| 12 | 115 | 117 |
| 13 | 110 | 110 |
| 14 | 115 | 110 |
| 15 | 110 | 110 |
| 16 | 115 | 115 |
| 17 | 116 | 117 |
| 18 | 110 | 110 |
| 19 | 110 | 110 |
| 20 | 110 | 110 |

### (3) High Humidity Tests:

20 pieces of 5 cm×5 cm outer covers coated with the hydrophobic and lipophobic coating material of the present invention are prepared. A gloss meter is used to test the gloss of the coated outer covers initially and test it again after the outer covers are placed in an environment at a temperature of 50° C. and a relative humidity of 90% for 200 hours. The results are as follows:

| | Results Before Placed | Results After Placed |
|---|---|---|
| Serial Number of | at High Humidity | at High Humidity |
| Group | (GU) | (GU) |
| 1 | 110 | 110 |
| 2 | 105 | 105 |
| 3 | 111 | 111 |
| 4 | 110 | 110 |
| 5 | 109 | 110 |
| 6 | 110 | 110 |
| 7 | 110 | 110 |
| 8 | 115 | 115 |
| 9 | 109 | 110 |
| 10 | 110 | 110 |
| 11 | 110 | 111 |
| 12 | 115 | 115 |
| 13 | 110 | 110 |
| 14 | 115 | 115 |
| 15 | 110 | 110 |
| 16 | 115 | 115 |
| 17 | 115 | 116 |
| 18 | 110 | 110 |
| 19 | 110 | 110 |
| 20 | 105 | 105 |

### (4) Thermal Shock Tests:

20 pieces of 5 cm×5 cm outer covers coated with the hydrophobic and lipophobic coating material of the present invention are prepared. A gloss meter is used to test the gloss of the coated outer covers initially and test it again after the outer covers are placed at a temperature of 80° C. for 15 minutes and then −40° C. for 30 minutes cyclically 40 times. The results are as follows:

| Serial Number of | Results Before | Results After |
|---|---|---|
| Group | Thermal Shock (GU) | Thermal Shock (GU) |
| 1 | 115 | 116 |
| 2 | 115 | 115 |
| 3 | 110 | 111 |
| 4 | 110 | 110 |
| 5 | 109 | 110 |
| 6 | 115 | 115 |
| 7 | 110 | 110 |
| 8 | 115 | 115 |
| 9 | 109 | 110 |
| 10 | 110 | 110 |
| 11 | 110 | 110 |
| 12 | 107 | 110 |
| 13 | 110 | 109 |
| 14 | 115 | 116 |
| 15 | 110 | 110 |
| 16 | 115 | 115 |
| 17 | 115 | 115 |
| 18 | 110 | 110 |
| 19 | 110 | 110 |
| 20 | 115 | 115 |

The results of the above several weather resistance tests prove that the outer cover coated with the hydrophobic and lipophobic coating material of the present invention still has a superior antiglare function after the treatments of high temperature, low temperature, high humidity and thermal shock.

In conclusion, the present invention proposes a hydrophobic and lipophobic coating material, which makes a touchscreen easy to clean and exempts the touchscreen from oily stains. The spherical structure of the nanoparticles of the hydrophobic and lipophobic coating material generates a superior antiglare effect. The covalent bonds formed between the surface of the conductive layer (or the outer cover) and the silicon functional groups of the nanoparticles make the coating material firmly adhere to the conductive layer (or the outer cover) of a touchscreen and hard to peel off.

The abovementioned embodiments described above have proved that the present invention possesses utility, novelty and non-obviousness and meets the condition for a patent. Thus, the Inventor files the application for a patent. It will be appreciated if the patent is approved fast.

The embodiments described above are only to exemplify the present invention but not to limit the scope of the present invention. Any equivalent modification or variation according to the spirit of the present invention is to be also included within the scope of the present invention.

What is claimed is:

1. A hydrophobic and lipophobic coating material comprising nanoparticles with a molecule having the formula (I): 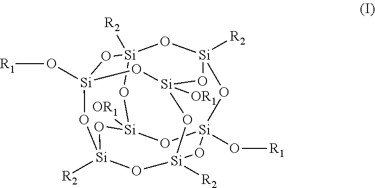
wherein R1 is selected from a group consisting of halogens, hydrogen, alkyl groups, alkoxy groups, hydroxyl group, alkenyl groups, alkynyl groups, acyl groups, aryl groups, carboxyl groups, alkoxycarbonyl groups, and aryloxycarboxyl groups, and wherein R2 is a functional group containing fluorine.

2. The hydrophobic and lipophobic coating material according to claim 1, wherein R1 of the formula (I) is selected from a group consisting of —H, —OH, —OCH₃, —OC₂H₅, —CH₃, —CH═CH₂, —OC₂H₄OCH₃ and —C₃H₆COOC₂H₅.

3. The hydrophobic and lipophobic coating material according to claim 1, wherein R2 of the formula (I) is selected from a group consisting of fluoropolyamide groups, fluoropolyimide groups, fluorobenzoyl groups, fluoroalkyl groups, fluorosilyl groups, fluoromethyl groups, 3-chloro-4-fluoro-benzenamine groups, perfluoroalkylolethoxyl groups, and N-perfluorooctylsulfonamide groups.

4. The hydrophobic and lipophobic coating material according to claim 1, wherein R2 of the formula (I) is Fₙ, and n is an integer greater than 1.

5. The hydrophobic and lipophobic coating material according to claim 1, wherein the nanoparticles with a molecule having the formula (I) have a diameter of 100-200 nm.

6. A touchscreen comprising a conductive layer where the hydrophobic and lipophobic coating material according to claim 1 is coated.

7. The touchscreen according to claim 6, wherein the conductive layer is made of Indium Tin Oxide, Antimony Tin Oxide, Aluminum Zinc Oxide, or Indium Zinc Oxide.

8. A touchscreen comprising an outer cover where the hydrophobic and lipophobic coating material according to claim 1 is coated.

9. The touchscreen according to claim 8, wherein the outer cover is made of glass, poly(methyl methacrylate), PolyVinyl Chloride, PolyCarbonate, poly(ethylene terephthate), or polyimide.
